(19) United States
(12) Patent Application Publication
(10) Pub. No.: US 2016/0335615 A1
(43) Pub. Date: Nov. 17, 2016

(54) WEARABLE DISPLAY DEVICE FOR DISPLAYING PROGRESS OF PAYMENT PROCESS ASSOCIATED WITH BILLING INFORMATION ON DISPLAY UNIT AND CONTROLLING METHOD THEREOF

(71) Applicant: LG Electronics Inc., Seoul (KR)

(72) Inventors: Sangwon KIM, Seoul (KR); Hyungjin KIM, Seoul (KR); Kang LEE, Seoul (KR); Sukwon KIM, Seoul (KR); Daehwan KIM, Seoul (KR); Woo JUNG, Seoul (KR); Yunsun CHOI, Seoul (KR); Yongjoon LEE, Seoul (KR)

(73) Assignee: LG ELECTRONICS INC., Seoul (KR)

(21) Appl. No.: 14/936,445

(22) Filed: Nov. 9, 2015

(30) Foreign Application Priority Data
May 14, 2015 (KR) 10-2015-0067272

(51) Int. Cl. G06Q 20/14; G06Q 20/42; G06F 3/0488; G06F 3/0482; G06F 3/0484; G06Q 20/32; H04N 5/232

(52) U.S. Cl. CPC G06Q 20/14; G06Q 20/3276; G06Q 20/42; H04N 5/23222; G06F 3/0482; G06F 3/04842; G06F 3/0488

(57) ABSTRACT

A wearable display device including a frame unit configured to be worn on a head of a user; a display unit configured to display an image to at least one of left and right eyes of the user; a camera configured to acquire a scene viewed by the user as an image; and a controller configured to control the camera to obtain an image of billing information viewed by the user, display a progress screen of a payment process associated with the billing information photographed on the display unit, receive a payment authorization input of the user for paying an amount included in the billing information, and complete payment for the amount included in the billing information when the received payment authorization input successfully matches a predefined payment authorization input.

Pursuant to 35 U.S.C. §119(a), this application claims the benefit of earlier filing date and right of priority to Korean Application No. 10-2015-0067272, filed on May 14, 2015, the contents of which are hereby incorporated by reference herein in their entirety.

### BACKGROUND OF THE INVENTION

1. Field of the Invention

The present invention relates to a wearable display device, and more particularly, to a wearable display device and controlling method thereof. Although the present invention is suitable for a wide scope of applications, it is particularly suitable for displaying progress of a payment process associated with billing or price information on a display unit.

2. Discussion of the Related Art

Generally, mobile terminals can be classified into non-wearable devices and wearable devices according to whether to be worn on a user's body. Particularly, among the wearable terminals, a mobile terminal that can be worn on a user's head (i.e., head mounted device) has a display unit to show an image directly to a user's eyes.

Functions of the wearable display device tend to be diversified. Examples of such functions include data and voice communications, photography and videography through a camera, voice recording, playback of music files through a speaker system, and output of images or videos through a display unit. Some terminals include additional functionality which supports game playing while other terminals are configured as multimedia players. As financial payment using the mobile terminal has emerged as interest recently, financial payment using the wearable display device has been also received attention.

Meanwhile, the wearable display device differs from the general mobile terminal in receiving a user's input. Therefore, it is necessary for the financial payment using the wearable display device to consider UX and UI different from those of the general mobile terminal.

### SUMMARY OF THE INVENTION

Accordingly, embodiments of the present invention are directed to a mobile terminal and controlling method thereof that substantially obviate one or more problems due to limitations and disadvantages of the related art.

One object of the present invention is to provide a wearable display device and controlling method thereof, which improves user convenience.

Another object of the present invention is to provide a wearable display device and controlling method thereof, which provides a payment method.

Technical tasks obtainable from the present invention are non-limited by the above-mentioned technical tasks. And, other unmentioned technical tasks can be clearly understood from the following description by those having ordinary skill in the technical field to which the present invention pertains.

Additional advantages, objects, and features of the invention will be set forth in the disclosure herein as well as the accompanying drawings. Such aspects may also be appreciated by those skilled in the art based on the disclosure herein.

To achieve these objects and other advantages and in accordance with the purpose of the invention, as embodied and broadly described herein, a wearable display device according to an embodiment of the present invention may include a frame unit having a shape wearable on a head of a user, a display unit connected to the frame unit directly or indirectly, the display unit configured to show an image to at least one of left and right eyes of the user, a camera connected to the frame unit directly or indirectly, the camera configured to photograph a direction of the user's eyes in a surrounding environment of the user by being disposed adjacent to the display unit, and a controller connected to the frame unit directly or indirectly, the controller controlling the display unit to display the image, the controller processing the image photographed through the camera, the controller controlling a progress screen of a payment process associated with billing information photographed through the camera to be displayed on the display unit, the controller controlling an amount corresponding to the billing information to be paid by receiving a payment authorization input of the user.

In another aspect of the present invention, in a wearable display device including a frame unit having a shape wearable on a head of a user, a display unit configured to show an image to at least one of left and right eyes of the user, a camera configured to photograph of a direction of the user's eyes in a surrounding environment of the user by being disposed adjacent to the display unit, and a controller controlling the display unit to display the image or processing the image photographed through the camera, a method of controlling the wearable display device according to an embodiment of the present invention may include a step (a) for the controller to receive billing information photographed through the camera, a step (b) for the controller to control a progress screen of a payment process associated with the received billing information to be displayed on the display unit, a step (c) for the controller to receive a payment authorization input of the user, and a step (d) for the controller to control an amount corresponding to the billing information to be paid.

Effects obtainable from the present invention may be non-limited by the above mentioned effect. And, other unmentioned effects can be clearly understood from the following description by those having ordinary skill in the technical field to which the present invention pertains. It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. The above and other aspects, features, and advantages of the present invention will become more apparent upon consideration of the following description of preferred embodiments, taken in conjunction with the accompanying drawing figures. In the drawings:

FIG. 1 is a perspective view of a glass-type wearable display device according to one embodiment of the present specification;

FIG. 2 is a schematic block diagram of electric connection between components that can be included in a wearable display device according to the present specification;

FIG. 3 is a diagram illustrating an example of paying a specific amount using a wearable display device according to the present specification;

FIG. 4 is a diagram illustrating an example of a payment authorization input according to a touch input of a user;

FIG. 5 is a diagram illustrating an example of a payment authorization input according to a payment signature input of a user;

FIG. 6 is a diagram illustrating an example of a payment authorization input according to biometric information of a user;

FIG. 7 illustrates an example that a different user participates in a payment process according to one embodiment of the present specification;

FIG. 8 illustrates an example that users participating in a payment process make payments by equally splitting a prescribed amount with each other;

FIG. 9 illustrates an example that users participating in a payment process make payments by splitting a prescribed amount into different rates with each other;

FIG. 10 illustrates an example that one of at least two users participating in a payment process determines a payment amount of each of the users in order to progress the payment process;

FIG. 11 illustrates an example that one of users participating in a payment process pays a payment amount of the corresponding user together with that of a different user in order to progress the payment process; and

FIG. 12 is a schematic flowchart to describe a controlling method of a wearable display device according to the present specification.

### DETAILED DESCRIPTION OF THE INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

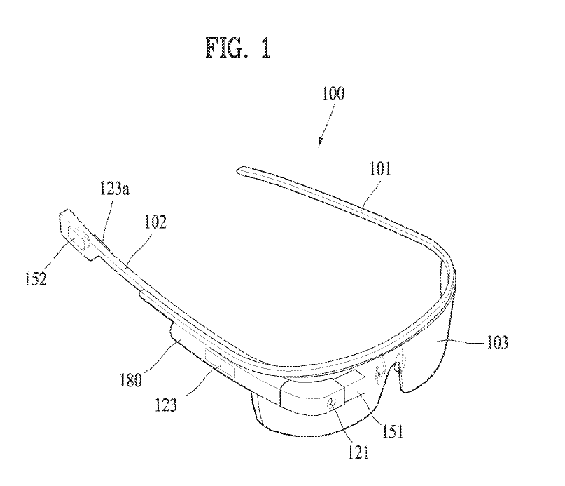

FIG. 1 is a perspective view of a glass-type wearable display device according to one embodiment of the present specification. Referring to FIG. 1, a wearable display device 100 according to the present specification include a frame unit 101 and 102, a display unit 151, a camera 121 and a controller 180.

The glass-type device 100 can be wearable on a head of a human body and provided with a frame unit therefor. The frame unit may be made of a flexible material to be easily worn. It is illustrated in the drawing that the frame unit includes a first frame 101 and a second frame 102, which may be made of different materials.

The frame unit 101 and 102 can be supported on the head and define a space for mounting various components. As illustrated, electronic components, such as a controller 180, an audio output unit 152, and the like, may be mounted to the frame unit. Also, a lens 103 for covering either or both of the left and right eyes may be detachably coupled to the frame unit. It is shown in the drawing that the display unit 151, the camera 121 and the controller 180 are connected to the frame unit on one side of the user's head directly or indirectly, by which locations of the display unit 151, the camera 121 and the controller 180 are non-limited.

The display unit 151 to show an image directly to either or both of the left and right eyes may be detachably coupled to the frame unit 101 and 102. The display unit 151 may be implemented as a head mounted display (HMD). The HMD refers to display techniques by which a display is mounted to a head to show an image directly to a user's eyes. In order to provide an image directly to the user's eyes when the user wears the glass-type device 100, the display unit 151 may be located to correspond to either or both of the left and right eyes. FIG. 1 illustrates that the display unit 151 is located on a portion corresponding to the right eye to output an image viewable by the user's right eye.

The display unit 151 may project an image onto the user's eye using a prism. The prism may be formed from optically transparent material such that the user can view both the projected image and a general visual field (a range that the user views through the eyes) in front of the user. In such a manner, the image output through the display unit 151 may be viewed while overlapping with the general visual field. The wearable display device 100 according to the present specification may provide an augmented reality (AR) by overlaying a virtual image on a realistic image or background using the display unit 151.

The camera 121 may be disposed adjacent to the display unit 151 and take a photograph of a direction of the user's eyes in the surrounding environment of the user. As the display unit 151 is connected to the frame unit to show an image to either or both of the left and right eyes, the camera 121 is also located adjacent to either or both of the left and right eyes, thereby being able to acquiring the scene that the user is currently viewing as an image. Although FIG. 1 shows that the camera 121 is disposed at the controller 180, the camera 121 may be disposed at any location of the wearable display device 100. For instance, the camera 121 may be directly connected to the frame unit 101 and 102. In some embodiments, multiple cameras may be used to acquire a stereoscopic image.

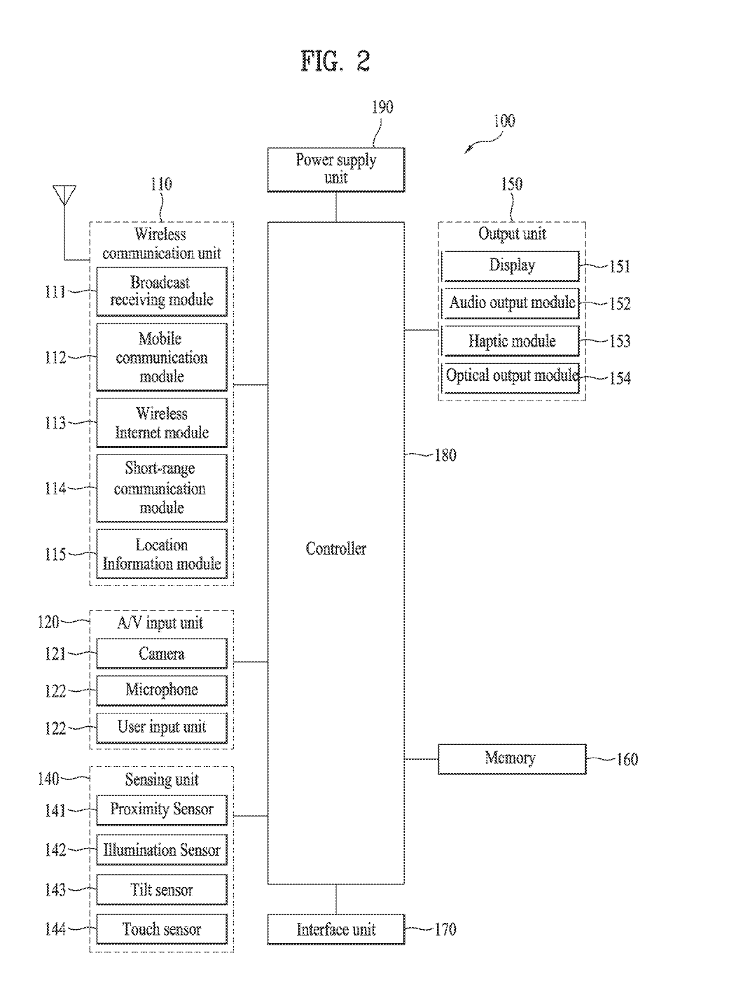

FIG. 2 is a schematic block diagram of electric connection between components that can be included in the wearable display device 100 according to the present specification. Referring to FIG. 2, the wearable display device 100 may further include a wireless communication unit 110, an input unit 120, a sensing unit 140, an output unit 150, an interface unit 160, a memory 170, and a power supply unit 190 besides the above-mentioned the display unit 151, the camera 121 and the controller 180. Since all the components shown in FIG. 2 is not a prerequisite to implement the wearable display device 100 according to the present specification, the wearable display device 100 described in the present specification may have greater or fewer components.

The wireless communication unit 110 typically includes one or more modules which permit communications such as wireless communications between the wearable display device 100 and a wireless communication system, communications between the wearable display device 100 and another the wearable display device, communications between the mobile terminal 100 and an external server. Further, the wireless communication unit 110 typically includes one or more modules which connect the wearable display device 100 to one or more networks. To facilitate such communications, the wireless communication unit 110 includes at least one selected from the group consisting of a broadcast receiving module 111, a mobile communication module 112, a wireless Internet module 113, a short-range communication module 114, and a location information module 115.

The input unit 120 includes a microphone 122 for inputting an audio signal, an audio input unit or a user input unit 123 for allowing the user to input information. Audio data or image data obtained by the input unit 120 may be analyzed and processed according to a control command of the user. The above-mentioned camera 121 may be also included in the input unit 120.

The user input unit 123 for allowing the user to input the control command may be included in the glass-type wearable display device 100. In order to implement the user input unit 123, various types of techniques such as a tactile manner, which allows the user to operate a device using the sense of touch like touch, push and the like, and a touchpad using a touch sensor may be used. FIG. 1 shows that the user input unit 123 using touch input technique is included in the controller 180.

The sensing unit 140 may include one or more sensors configured to sense internal information of the device 100, information on the surrounding environment of the device 100, user information and the like. For example, the sensing unit 140 may include at least one selected from the group consisting of a proximity sensor 141, an illumination sensor 142, a tilt sensor 143, a touch sensor 144, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, a gas sensor, etc.), and a chemical sensor (for example, an electronic nose, a health care sensor, a biometric sensor, etc.). The device 100 disclosed in this specification may be configured to utilize information obtained from sensing unit 140, i.e., information obtained from one or more sensors of the sensing unit 140 and combinations thereof. For instance, the tilt sensor 143 may sense a tilt of the device 100 and a vertical or horizontal movement of the device 100 by processing values sensed by the G-sensor, the gyroscope sensor and the acceleration sensor.

The output unit 150 is typically configured to output various types of information, such as audio, video, tactile output and the like. The output unit 150 may include at least one selected from the group of a display unit 151, an audio output module 152, a haptic module 153, and an optical output module 154.

The interface unit 160 serves as an interface with various types of external devices that can be coupled to the device 100. The interface unit 160, for example, may include at least one selected from the group consisting of wired/wireless headset ports, external power supply ports, wired/wireless data ports, memory card ports, ports for connecting a device having an identification module, audio input/output (I/O) ports, video I/O ports, earphone ports. In some cases, the device 100 may perform assorted control functions associated with a connected external device, in response to the external device being connected to the interface unit 160

The memory 170 is typically implemented to store data to support various functions or features of the device 100. For instance, the memory 170 may be configured to store application programs executed in the device 100, data or instructions for operations of the device 100, and the like. Some of these application programs may be downloaded from an external server via wireless communication. Other application programs may be installed within the device 100 at time of manufacturing or shipping, which is typically the case for basic functions of the device 100 (for example, receiving a call, placing a call, receiving a message, sending a message, and the like). It is common for application programs to be stored in the memory 170, installed in the device 100, and executed by the controller 180 to perform an operation (or function) for the device 100.

The controller 180 typically controls overall operations of the device 100 including an operation associated with the application program as well as an operation of processing the image photographed through the camera 121 to display the corresponding image on the display unit 151. The controller 180 can process or provide appropriate information or function to a user by processing signals, data, information and the like input or output through the above-mentioned components or running application programs saved in the memory 170. In order to run the application programs saved in the memory 170, the controller 180 controls some or all of the components described with reference to FIG. 2 or any combination thereof.

The power supply unit 190 is configured to receive external power or provide internal power in order to supply appropriate power required for operating elements and components included in the device 100. The power supply unit 190 may include a battery and the battery may be configured to be embedded in the device body or configured to be detachable from the device body.

At least one portion of the above-mentioned components can cooperatively operate to embody operations, controls or controlling methods of the device according to various embodiments mentioned in the following description. In addition, the operations, controls or controlling methods of the device can be embodied on the device 100 by running at least one or more application programs saved in the memory 170.

The controller 180 according to the present specification controls the display unit 151 to display a progress screen of a payment process associated with billing or price information photographed through the camera 121. In addition, the controller 180 can control an amount corresponding to the billing or price information to be paid by receiving a payment authorization input of a user.

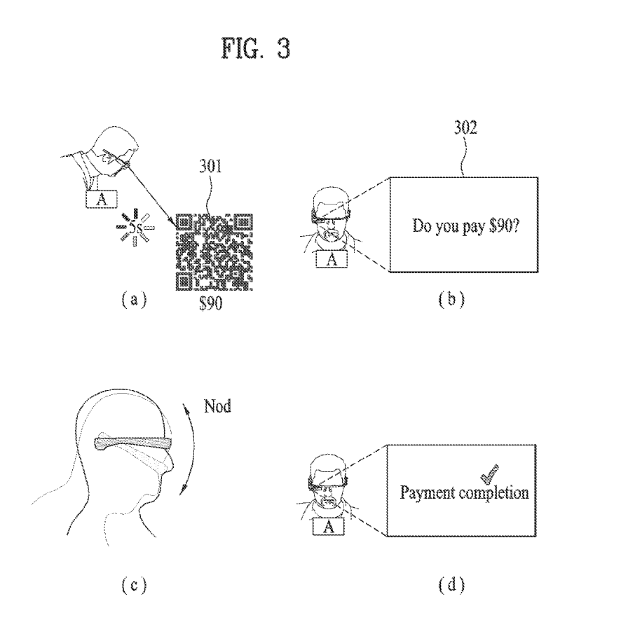

FIG. 3 is a diagram illustrating an example of paying a specific amount using a wearable display device according to the present specification. Referring to FIG. 3(a), a user A wearing the wearable display device 100 according to an embodiment of the present specification can look at billing information. In particular, the user A is currently viewing billing information 301 related to the amount that should be paid by the user A. As mentioned in the foregoing description, the camera 121 is configured to acquire the scene viewed by a user as an image. Thus, an image related to the billing information 301 can be obtained by the camera 121 and information on the obtained image can be processed by the controller 180. According to an embodiment of the present specification, the billing information 301 corresponds to a QR code. Therefore, such detailed information as a payment amount, a payment object, a service provider and the like can be obtained according to information obtained through the QR code.

Since all QR codes obtained through the camera 121, i.e., all of billing information may not correspond to payment objects for which the user intends to pay, a payment intention and the payment object should be confirmed and then processed. According to one embodiment of the present specification, the controller 180 can control the display unit 151 to display a progress screen of a payment process associated with billing information photographed for a preset time (e.g., 5 seconds) in billing information photographed through the camera 121. Further, an amount corresponding to the billing information can be paid by receiving the payment authorization input of the user.

Referring to FIG. 3(b), a progress screen 302 of a payment process displayed on the display unit 151 can be viewed. In particular, since a payment amount is displayed on the progress screen 302, the user can check the amount that should be paid by the user. Referring to FIG. 3(c), an example of a user input for authorizing the displayed payment amount can be input. As mentioned in the foregoing description, the controller 180 can receive a signal for indicating whether the device 100 is tilted through the tilt sensor 143.

According to one embodiment of the present specification, when determining a presence or non-presence of the payment authorization input during the payment process, the controller 180 can process a user's head movement as the payment authorization input by receiving the tilt signal. Although a motion of nodding user's head is illustrated as an example of the payment authorization input in FIG. 3(c), various motions including the motion of nodding the head may be used as the payment authorization input in this specification.

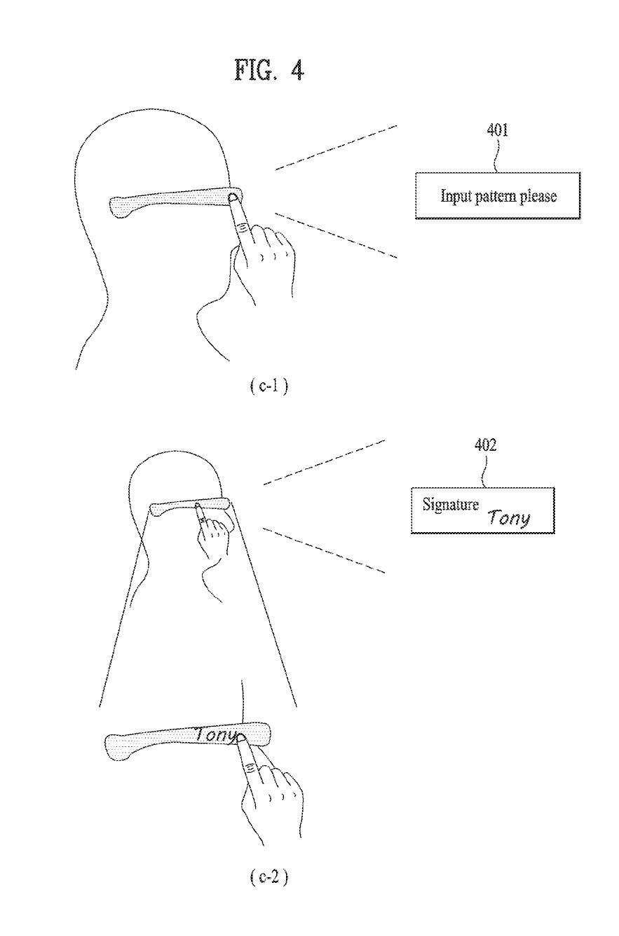

Next, FIGS. 4 to 6 are diagrams illustrating various examples of the payment authorization input i.e., the step of FIG. 3(c). In particular, FIG. 4 is a diagram illustrating an example of a payment authorization input according to a touch input of a user. As mentioned in the foregoing description, the controller 180 can receive the user's touch input through the touch sensor 144.

According to one embodiment of the present specification, when determining a presence or non-presence of the payment authorization input during the payment process, the controller 180 can process a user's touch input as the payment authorization input by receiving the touch signal. Referring to FIG. 4(c-1), a guide message of ‘Please input a pattern’ on a progress screen 401 of a payment process displayed on the display unit 151 can be viewed by the user. The user can input a preset touch pattern according to the guide message.

If a touch pattern of the user matches the preset touch pattern, the controller 180 can determine it as the payment authorization input of an authorized user and then progress the payment. Referring to FIG. 4(c-2), a guide message of ‘signature’ on a progress screen 402 of a payment process displayed on the display unit 151 can be viewed by the user. The user can input a payment signature of the corresponding user according to the guide message. If the payment signature of the user matches a preset payment signature, the controller 180 can determine it as the payment authorization input of the authorized user and then progress the payment.

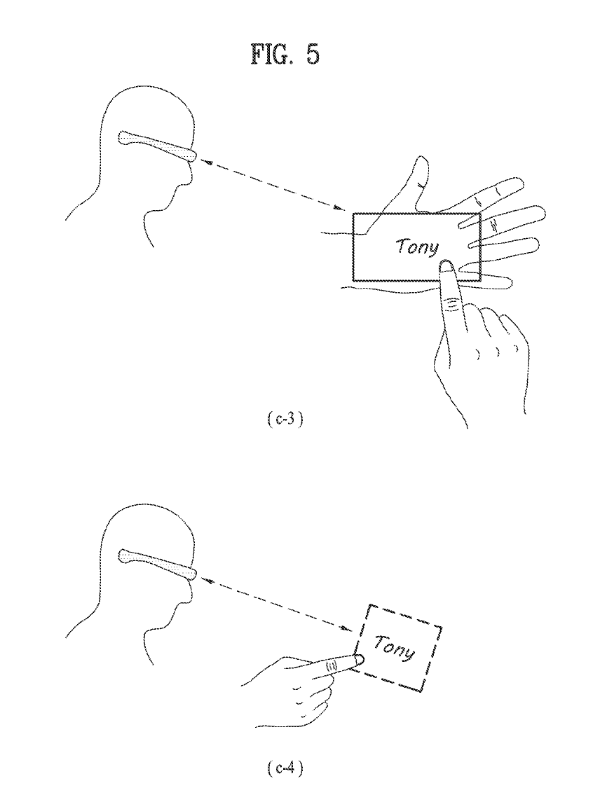

Next, FIG. 5 is a diagram illustrating an example of a payment authorization input according to a payment signature input of a user. As mentioned in the foregoing description, the camera 121 can acquire a scene viewed by a user as an image and the controller 180 can process the acquired image. According to another embodiment of the present specification, when the controller 180 determines a presence or non-presence of the payment authorization input during the payment process, if a signature image photographed through the camera 121 matches a previously saved payment signature image of the user, the controller 180 can process the signature image photographed through the camera 121 as the payment authorization input. FIG. 5(c-3) shows an example that the user inputs a payment signature to a user's palm using fingers. In addition, FIG. 5(c-4) shows an example that the user inputs the payment signature to a material such as a paper using a pen. In the case of both examples in FIGS. 5(c-3) and (c-4), signature images are obtained through the camera 121 and the controller 180 can process the obtained signature images.

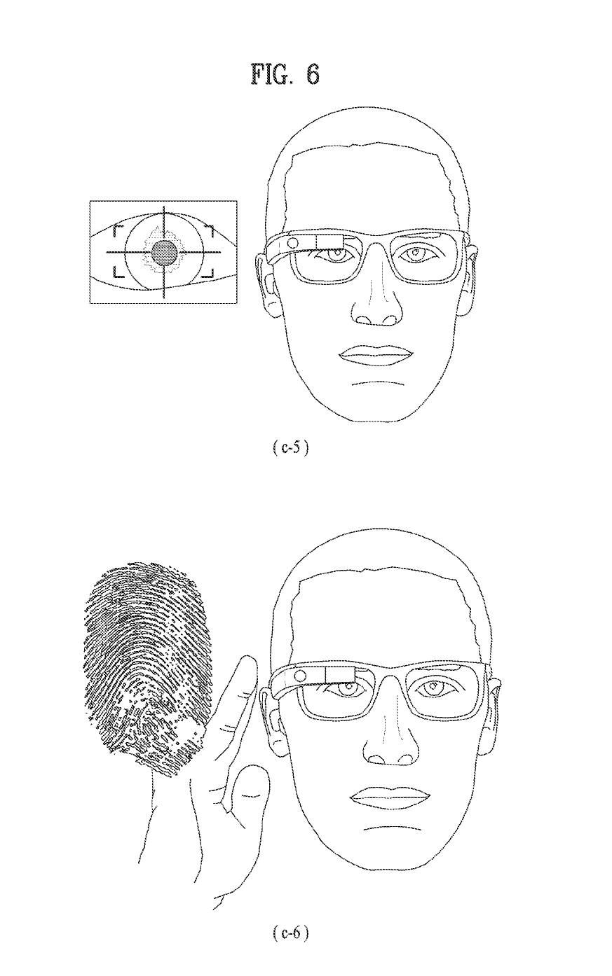

FIG. 6 is a diagram illustrating an example of a payment authorization input according to biometric information of a user. The wearable display device 100 according to an embodiment of the present specification may further include a biometric information sensor that can read biometric information of a user. The biometric information sensor can sense unique biometric information, which is different from person to person, and output a sensing result as an electrical signal to the controller 180. Examples of the biometric information sensor include an iris recognition sensor, a fingerprint sensor, a hand dorsal vein sensor, a palm sensor, a voice recognition sensor, and the like. The biometric information sensor may be implemented with at least one or more sensors. Preferably, the wearable display device 100 according to an embodiment of the present specification may include either or both of the fingerprint sensor capable of sensing a user's fingerprint and the iris recognition sensor capable of sensing a user's iris.

FIG. 6(c-5) shows an example of applying the iris recognition sensor and FIG. 6(c-6) shows an example of applying the fingerprint sensor. If biometric information received from the biometric information sensor matches previously saved biometric information, the controller 180 can process the biometric information received from the biometric information sensor as the payment authorization input. In order to process the payment, the controller 180 can determine whether biometric information of either of the iris recognition sensor and the fingerprint sensor matches the previously saved biometric information. Alternatively, the controller 180 can determine whether biometric information of two or more sensors matches the previously saved biometric information.

In addition, a different user can participate in the payment process. For instance, the user can pay an amount of the user together with that of the different user or make a payment by splitting a prescribed amount with the different user. In this instance, if at least one different user except the user participates in the payment process, the controller 180 can control participant information to be displayed on the display unit 151.

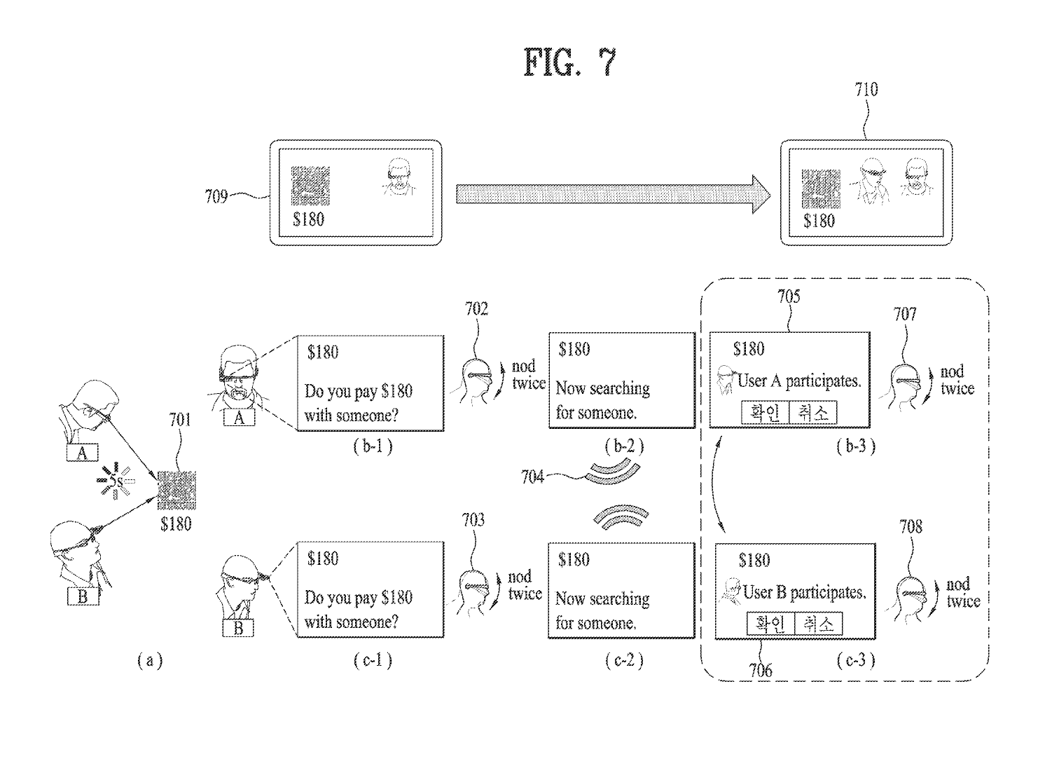

FIG. 7 illustrates an example that another user participates in a payment process according to one embodiment of the present specification. Referring to FIG. 7(a), a user A and a user B recognize a QR code corresponding to billing information through their own devices, respectively. In this instance, the controller 180 of each of the devices displays an image asking its user whether to allow a different user to participate in payment on the display unit 151 as shown in FIGS. 7(b-1) and (c-1). If the controller 180 of each of the devices senses a user input 702 and 703, the controller 180 of each of the devices attempts to transmit its own billing information or to receive billing information on the different user.

According to an embodiment of the present specification, the controller 180 can receive participant information through the wireless communication unit 110. For example, the device 100 can directly recognize participant information through communication with a different device 100. The device 100 can recognize a QR code and then inform all nearby devices of the recognized QR code. The wireless communication unit 110 can perform communication between the wearable display device and a wireless communication system or communication between the wearable display device and the different wearable display device. The device 100 that has been received the information from the different device 100 can transmit information on whether to participate in the payment to the different device 100 that has been transmitted the information on the QR code, according to whether to participate in the payment process.

In another example, the device 100 can recognize a QR code and then access a server address included in the QR code. In this instance, a different user can also recognize the same QR code through a different device and then access the server address included in the same QR code. The server can transmit information on all the users who access the server through the same QR code to each of the device. In addition, the controller 180 of each of the devices can receive information, which is transmitted by the server, on the different user through the wireless communication unit 110.

Although it is illustrated in FIG. 7 that the device 100 directly transceives the participant information with the different device 100 through wireless communication 704, the present specification is non-limited by the example shown in FIG. 7. As shown in FIGS. 7(b-3) and (c-3), after having received the information on the different user participating in the payment, the controller 180 of each of the devices can control the display unit 151 to display the participant information for its own user. In this instance, the controller 180 can control the display unit 151 to further display an image 705 and 706 for asking its own user to authorize the different user, who is displayed on the display unit 151, to actually participate in the payment.

Subsequently, if the controller 180 of each of the devices senses a user input 707 and 708 for authorizing the participation of the displayed different user, the participation in the payment process by the different user is completed. Consequently, the controller 180 can control an image indicating that the payment process is changed from the payment 709 by a single user into the payment 710 by two or more users to be displayed on the display unit 151. Although FIG. 7 shows the example that one additional participant except the original user participates in the payment process, the invention according to the present specification is not limited by the number of additional participants.

Meanwhile, as mentioned in the foregoing description, when a user makes a payment together with a different user, the user can pay an amount of the user together with that of the different user or the user can make a payment by dividing a prescribed amount with the different user. If the user applies an input to make the payment by dividing some or all of the payment amount with a participant selected by the user from participants participating in the payment process, the controller 180 can control a remaining payment amount of the user and a payment amount split to the selected participant to be displayed on the display unit 151 and then pay the remaining payment amount of the user by receiving the payment authorization input of the user.

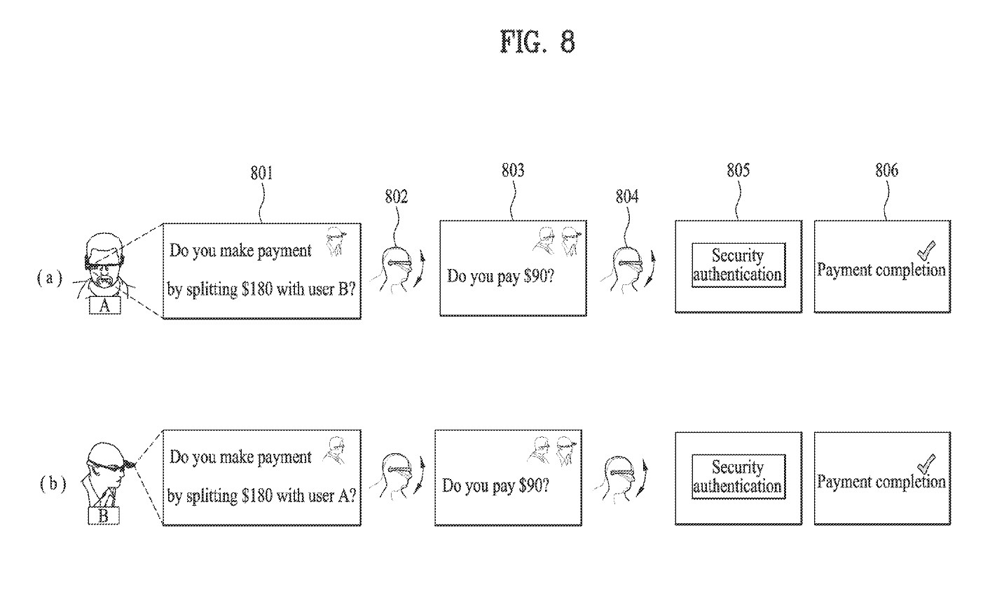

FIG. 8 illustrates an example that users participating in a payment process pay by equally dividing a prescribed amount with each other. FIG. 8(a) is a diagram illustrating an example of an image displayed on a display unit 151 of a user A and FIG. 8(b) is a diagram illustrating an example of an image displayed on a display unit 151 of a user B. Similar to the example shown in FIG. 7, FIG. 8 illustrates a case that participation in a payment process by a different user is determined.

The controller 180 can control an image 801 for asking its user whether to make a payment by splitting a payment amount with a different participant to be displayed on the display unit 151. In addition, if the controller 180 senses a user input 802 for authorizing that the user makes the payment by splitting the payment amount with the different participant, the controller 180 can control an image 803 indicating a split payment amount to be displayed on the display unit 151. Subsequently, if the controller 180 senses a user input 804 for authorizing payment for the split amount, the controller 180 can complete the payment through security authentication.

Since controlling of the security authentication 805 and payment completion 806 is described with reference to FIG. 3, redundant description thereof will be omitted. Moreover, since the controller 180 of the device worn by the user B also performs the same process, redundant description thereof will be omitted. Although FIG. 8 shows the example of payment by dividing a prescribed amount with a single participant, the invention according to the present specification is not limited by the number of participants. Further, a case of paying by dividing a prescribed amount into different rates with a different participant may occur besides the case of paying by dividing the prescribed amount into the same rate with the different user as shown in FIG. 8.

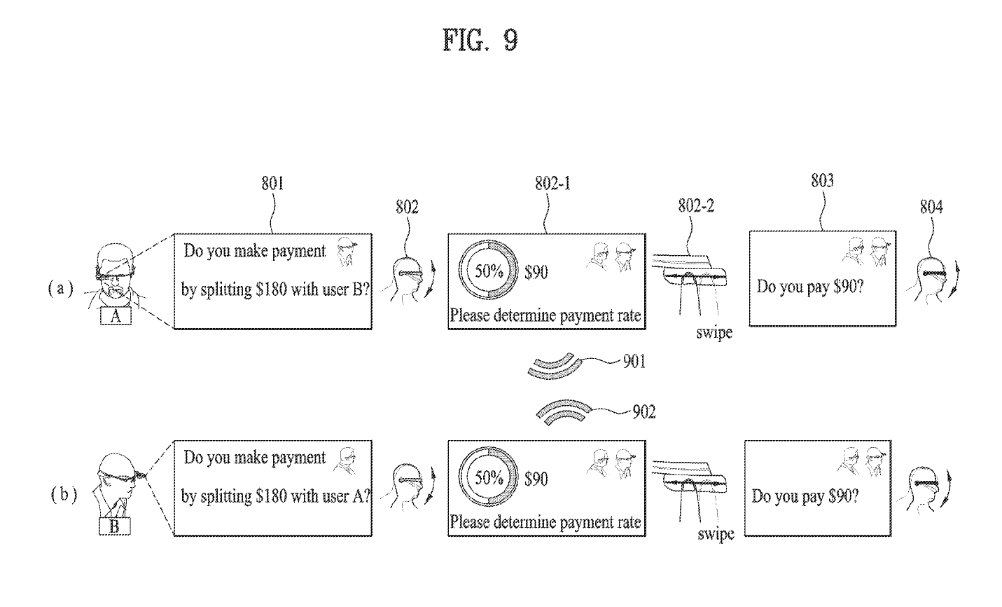

FIG. 9 illustrates an example that users participating in a payment process pay by dividing a prescribed amount into different rates with each other. Referring to FIG. 9, it may be checked that reference numbers 802-1 and 802-2 are added unlike the example shown in FIG. 8. The reference numbers, which are the same as those in FIG. 8, in FIG. 9 means that a payment process in FIG. 9 is performed in the same manner described with reference to FIG. 8. Moreover, although the reference numbers 805 and 806 among the reference numbers in FIG. 8 are not shown in FIG. 9, they are omitted just for simplification of the drawing. Thus, description will be made centering on situations related to the newly added reference numbers 802-1 and 802-2.

If the controller 180 senses the user input 802 for authorizing that the user makes the payment by splitting the payment amount with the different participant, the controller 180 can control an image 802-1 for requesting an input for a payment rate to the user to be displayed on the display unit 151. In addition, the controller 180 can control the payment rate and a payment amount according to the payment rate to be displayed on the display unit 151 by receiving the user input. According to one embodiment of the present specification, a user input 802-2 for the payment rate may be received through the touch sensor 144.

In addition, when the user makes a payment by splitting a prescribed amount with the different user, determination of the payment rate of the user naturally affects the payment rate of the different participant. Therefore, the controller 180 can transmit a result of the input for the payment rate to the device of the different participant through the wireless communication unit 110 (cf. reference number 901 in FIG. 9). Further, the controller 180 can receive an input, which is input by the different participant, for the payment rate through the wireless communication unit 110 (cf. reference number 902 in FIG. 9). Further, besides a case that all participants can participate in determining a rate for a payment amount similar to the example shown in FIG. 9, a case that one among participants determines a payment amount of each of the participants may occur.

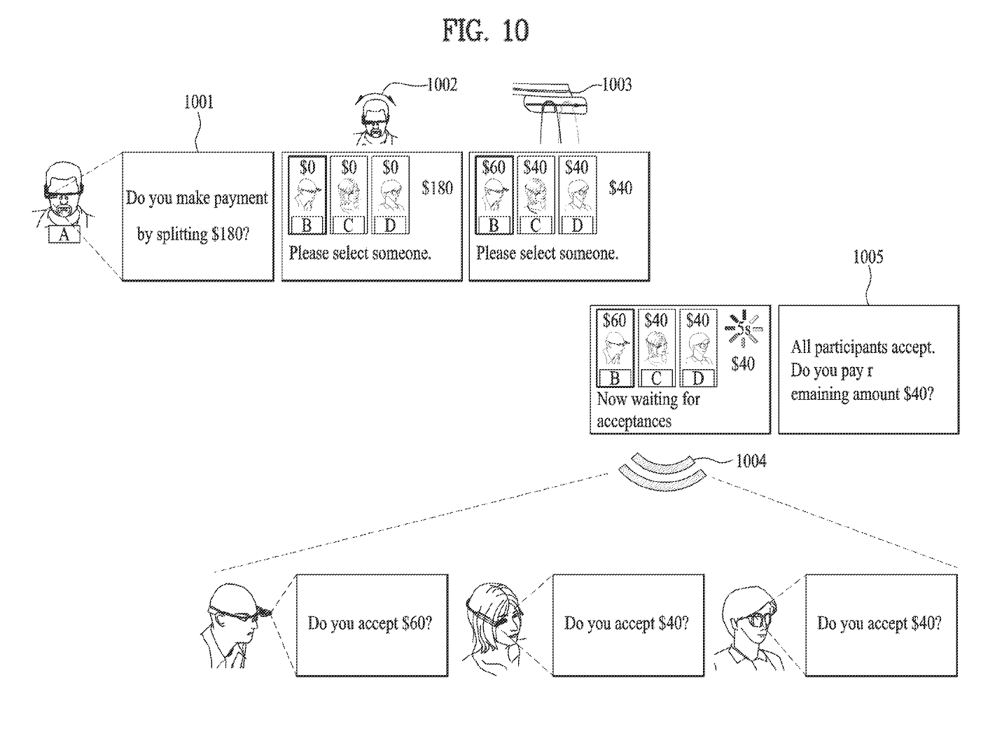

FIG. 10 illustrates an example that one of at least two users participating in a payment process determines a payment amount of each of the users in order to progress the payment process. In particular, FIG. 10 illustrates a situation that total four participants participate together in a payment process to pay for food that each of the participants eats. Billing information is photographed through a camera included in a device of a participant A among the four participants. In this instance, it is expected that the participant A inputs in order to determine respective payment amounts of the rest of participants (i.e., participants B, C and D) participating in the payment process to process respective payments.

The controller 180 can select a participant from the participants by receiving a user input and then receive an input for a payment amount of the selected participant. The input for selecting the participant may correspond to an input 1002 of shaking a user's head from side to side. Also, the input for determining the payment amount of the selected participant may correspond to an input 1003 of touching the touch sensor 144. If the respective payment amounts of participant are determined, the controller 180 can transmit information on the payment amount to the respective participants by controlling the wireless communication unit 110 (1004).

If each of participants determines that the payment amount is reasonable after checking the payment amount, each of participants transmit information on payment acceptance. If the controller 180 receives all of the information on the payment acceptance from all the participants through the wireless communication unit 110, the controller 180 can control an image 1005 containing related information to be displayed on the display unit 151. Since details of the remaining payment process is described with reference to FIG. 3, redundant description thereof will be omitted.

The above-mentioned example relates to paying the prescribed amount by dividing it with the different user. Besides this method, a user can pay a payment amount of the user together with that of the different person r. In particular, the user can pay the payment amount of the different user in place of the different user.

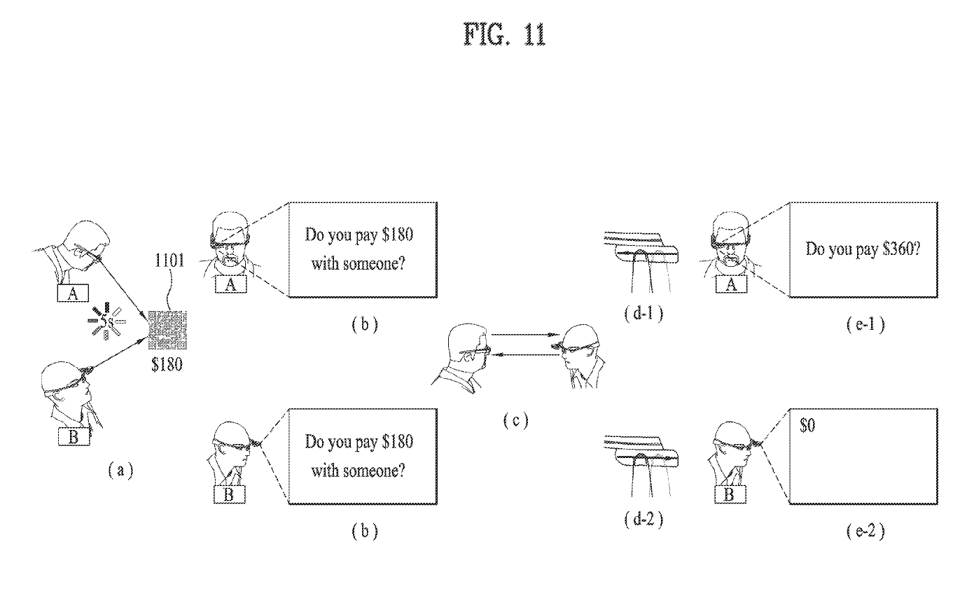

Next, FIG. 11 illustrates an example that one of users participating in a payment process pays a payment amount of the corresponding user together with that of a different user in order to progress the payment process. Referring to FIG. 11(a), a user A and a user B recognize billing information 1101. Also, as shown in FIG. 11(b), the controller 180 of each device can confirm an intention of participating in a payment process of a different user. In this instance, as shown in FIG. 11(c), an input for participating in the payment process of the different user can be performed in a manner that the users look at each other. In particular, the controller 180 can receive information on the different user through the camera 121. In addition, the controller 180 can receive a user input for determining whether to transmit a payment amount of the user to the different user or to receive a payment amount of the different user from the different user.

According to one embodiment of the present specification, if a gesture of sweeping the touch sensor 144 from the outside to the inside of a user's body is sensed through the touch sensor 144, the controller 180 can control the sum of a payment amount of the user and some or all of a payment amount of a selected participant to be displayed on the display unit 151. According to another embodiment of the present specification, if a gesture of sweeping the touch sensor 144 from the inside to the outside of a user's body is sensed through the touch sensor 144, the controller 180 can control a remaining payment amount of the user and a payment amount split to a selected participant to be displayed on the display unit 151.

Referring to FIG. 11(d-1), the user A inputs the gesture of sweeping the touch sensor from the outside to the inside of the user's body. In particular, the user A inputs the gesture in order to pay the payment amount of the user B instead of the user B. Referring to FIG. 11(d-2), the user B inputs the gesture of sweeping the touch sensor from the inside to the outside of the user's body. In particular, the user B inputs the gesture in order to make a request for paying the payment amount of the user B to the user A.

As a result of the above-mentioned inputs, the controller 180 of the user A can control the sum of the payment amount of the user A and the payment amount of the user B to be displayed on the display unit 151 as shown in FIG. 11(e-1). Moreover, the controller 180 of the user B can control the remaining payment amount of the user B to be displayed on the display unit 151 as shown in FIG. 11(e-2). Since details of the later payment process is described with reference to FIG. 3, redundant description thereof is omitted.

Meanwhile, in describing the payment process according to an embodiment of the present specification, methods for paying the payment amount may be predefined using various types of payment services such as a bank account, a credit card, a check card, a debit card and the like. Therefore, if payment intention of the user is checked, the controller 180 pays the amount corresponding to the payment amount to a service provider contained in the billing information using the predefined payment mean. Since various methods for paying the payment amount according to various payment means are disclosed to public, detailed description thereof will be omitted.

Hereinafter, a method of controlling a wearable display device according to the present specification will be described. In describing the controlling method, details of the components of the wearable display device are explained in the foregoing description, redundant description thereof will be omitted.

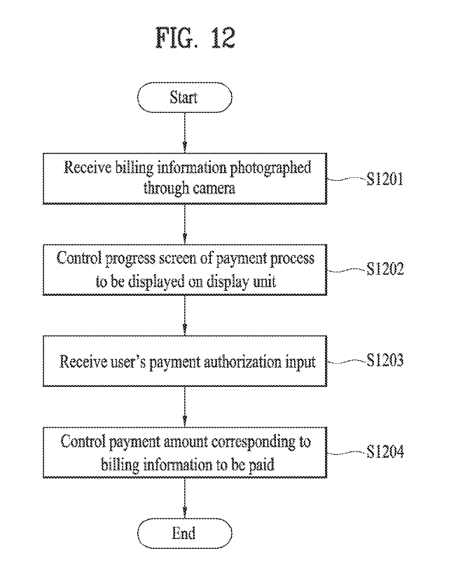

FIG. 12 is a schematic flowchart to describe a controlling method of a wearable display device according to the present specification. First, the controller 180 can receive billing information photographed through the camera 121 (S1201). Subsequently, the controller 180 can control a progress screen of a payment process associated with the received billing information to be displayed on the display unit 151 (S1202). Thereafter, when the controller receives a payment authorization input of a user (S1203), the controller 180 can control an amount corresponding to the billing information to be paid (S1204).

Accordingly, the present invention provides several advantages. According to at least one of embodiments of the present invention, a wearable display device for improving user convenience is provided. In addition, according to an embodiment of the present invention, a wearable display device for providing a payment method can be provided. Further, according to an embodiment of the present invention, a wearable display device capable of minimizing user's actions for payment and controlling method thereof can be provided.

Various terms used in this specification are general terms selected in consideration of functions of the embodiments disclosed in this specification but may vary according to the intentions or practices of those skilled in the art or the advent of new technology. Additionally, certain terms may have been arbitrarily selected and in this instance, their meanings are described in detail herein. Accordingly, the terms used in this specification should be interpreted based on substantial implications that the terms have and the contents across this specification not the simple names of the terms.

The present invention encompasses various modifications to each of the examples and embodiments discussed herein. According to the invention, one or more features described above in one embodiment or example can be equally applied to another embodiment or example described above. The features of one or more embodiments or examples described above can be combined into each of the embodiments or examples described above. Any full or partial combination of one or more embodiment or examples of the invention is also part of the invention.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. A wearable display device, comprising:
a frame unit configured to be worn on a head of a user;
a display unit configured to display an image to at least one of left and right eyes of the user;
a camera configured to acquire a scene viewed by the user as an image; and
a controller configured to:
control the camera to obtain an image of billing information viewed by the user,
display a progress screen of a payment process associated with the billing information photographed on the display unit,
receive a payment authorization input of the user for paying an amount included in the billing information, and
complete payment for the amount included in the billing information when the received payment authorization input successfully matches a predefined payment authorization input,
wherein the controller is further configured to display participant information on the display unit in response to at least one other participant besides the user participating in the payment for the amount included in the billing information.

2. The wearable display device of claim 1, wherein the billing information comprise a QR code.

3. The wearable display device of claim 1, wherein the controller is further configured to display the progress screen for a preset time on the display unit after obtaining the image of the billing information viewed by the user.

4. The wearable display device of claim 1, further comprising:
a tilt sensor configured to sense a tilting of the wearable display device,
wherein the received payment authorization input corresponds to a tilting pattern of the wearable device and the predefined payment authorization input corresponds to a preset tilting pattern of the wearable display device.

5. The wearable display device of claim 1, further comprising:
a touch sensor connected to the frame unit and configured to receive touch input,
wherein the received payment authorization input corresponds to a touch input on the touch sensor and the predefined payment authorization input corresponds to a preset touch input on the touch sensor.

6. The wearable display device of claim 1, wherein the received payment authorization input corresponds to a payment signature gesture image of the user captured by the camera and the predefined payment authorization input corresponds to a previously saved payment signature gesture image.

7. The wearable display device of claim 1, further comprising:
a biometric sensor,
wherein the received payment authorization input corresponds to biometric information of the user sensed by the biometric sensor and the predefined payment authorization input corresponds to previously saved biometric information.

8. The wearable display device of claim 7, wherein the biometric information sensor comprises at least one of a fingerprint sensor configured to sense a fingerprint of the user and an iris recognition sensor configured to sense an iris of the user.

9. The wearable display device of claim 1, wherein a first communication for obtaining the image of billing information is different from a second communication for receiving the participant information, further the first communication is performed between the wearable display device and a QR code and the second communication is performed between the wearable display device and a different wearable display device.

10. The wearable display device of claim 9, further comprising:
a wireless communication unit configured to provide wireless communication between the wearable display device and a wireless communication system or between the wearable display device and the different wearable display device,
wherein the controller is further configured to receive the participant information through the wireless communication unit.

11. The wearable display device of claim 9, wherein the at least one other participant includes at least a first other participant and a second other participant, and
wherein the controller is further configured to:
display a list including the first and second other participants on the display unit,
receive a user selection of the first and second participants displayed on the display unit,
receive a first amount of the billing information to be paid by the first other participant and a second amount of the billing information to be paid be the second other participant,
transmit, via the wireless communication unit, the first amount to the first other participant and the second amount to the second other participant, and
complete the payment when successfully receiving a confirmation input from the first and second other participants to pay the first and second amounts, respectively.

12. The wearable display device of claim 11, further comprising:
a touch sensor connected to the frame unit and configured to receive touch input,
wherein the controller is further configured to display the first and second amounts and a remaining amount to be paid by the user on the display unit in response to a preset touch input on the touch sensor.

13. The wearable display device of claim 9, wherein the controller is further configured to:
display information on the display unit indicating a request to pay the amount with another participant other than the user of the mobile terminal,
select the other participant when the camera module included in the mobile terminal obtains an image of the other participant,
receive an amount to be paid by the other participant, and
complete the purchase using the amount to be paid the other participant and a remaining amount to be paid by the user of the mobile terminal.

14. A method of controlling a wearable display device, the method comprising:
displaying, via a display unit of the wearable display device, an image to at least one of left and right eyes of a user;
acquiring, via a camera of the wearable display device, a scene viewed by the user as an image;
controlling, via a controller of the wearable display device, the camera to obtain an image of billing information viewed by the user;
displaying a progress screen of a payment process associated with the billing information photographed on the display unit;
receiving, via the controller, a payment authorization input of the user for paying an amount included in the billing information; and
completing payment for the amount included in the billing information when the received payment authorization input successfully matches a predefined payment authorization input,
wherein the method further comprises displaying participant information on the display unit in response to at least one other participant besides the user participating in the payment for the amount included in the billing information.

15. The method of claim 14, wherein the billing information comprise a QR code.

16. The method of claim 1, further comprising:
displaying the progress screen for a preset time on the display unit after obtaining the image of the billing information viewed by the user.

17. The method of claim 14, further comprising:
sensing, via a tilt sensor of the wearable device, a tilting of the wearable display device,
wherein the received payment authorization input corresponds to a tilting pattern of the wearable device and the predefined payment authorization input corresponds to a preset tilting pattern of the wearable display device.

18. The method of claim 14, wherein the received payment authorization input corresponds to a touch input on a touch sensor connected to the frame unit and the predefined payment authorization input corresponds to a preset touch input on the touch sensor.

19. The method of claim 14, wherein the received payment authorization input corresponds to a payment signature gesture image of the user captured by the camera and the predefined payment authorization input corresponds to a previously saved payment signature gesture image.

20. The method of claim 14, wherein the received payment authorization input corresponds to biometric information of the user sensed by a biometric sensor in the wearable display device and the predefined payment authorization input corresponds to previously saved biometric information.
